(19) United States
(12) Patent Application Publication
(10) Pub. No.: US 2023/0315809 A1
(43) Pub. Date: Oct. 5, 2023

(54) DATA PROCESSING APPARATUS, PROGRAM, AND DATA PROCESSING METHOD

(71) Applicant: Fujitsu Limited, Kawasaki-shi (JP)

(72) Inventors: Yasuhiro WATANABE, Kawasaki (JP); Hirotaka Tamura, Yokohama (JP)

(73) Assignee: Fujitsu Limited, Kawasaki-shi (JP)

(21) Appl. No.: 18/150,422

(22) Filed: Jan. 5, 2023

(30) Foreign Application Priority Data
Mar. 31, 2022 (JP) 2022-057999

(51) Int. Cl. G06F 17/18

(52) U.S. Cl. CPC G06F 17/18

(57) ABSTRACT

A data processing apparatus configured to: search for a combination of values of a plurality of state variables that minimizes or maximizes a value of an Ising-type evaluation function that includes the plurality of state variables, repeat determining whether to permit a change in a value of a first state variable among the plurality of state variables based on the first local field, and when the change in the value of the first state variable is permitted, updating the first local field based on the first weight value, updating the second local field that corresponds to a constraint condition in which the second weight value with the first state variable is non-zero based on the second weight value, and updating the first local field based on the second local field before the updating and the second local field after the updating.

### CROSS-REFERENCE TO RELATED APPLICATION

This application is based upon and claims the benefit of priority of the prior Japanese Patent Application No. 2022-57999, filed on Mar. 31, 2022, the entire contents of which are incorporated herein by reference.

### FIELD

The embodiments discussed herein are related to a data processing apparatus, a program, and a data processing method.

### BACKGROUND

There is an Ising device (also called a Boltzmann machine) that uses an Ising-type evaluation function (also called an energy function or the like) as a device that calculates a large-scale discrete optimization problem which Neumann computers are not good at.

The Ising device transforms the discrete optimization problem into an Ising model that represents spin behavior of a magnetic material. Then, the Ising device searches for a state of the Ising model where a value (corresponding to energy) of the Ising-type evaluation function is minimized by a Markov chain Monte Carlo method such as a simulated annealing method, a replica exchange method (also called a parallel tempering method), or the like. The state where a minimum value of local minimum values of the evaluation function is reached is to be an optimum solution. Note that the Ising device may search for a state where the value of the evaluation function is maximized by changing a sign of the evaluation function. A state of the Ising model may be represented by a combination of values of a plurality of state variables. As a value of each of the state variables, 0 or 1 may be used.

The Ising-type evaluation function is defined by, for example, a function in a quadratic form such as the following Expression (1).

$$[ Expression 1 ]$$

$$E ( x ) = - {\sum }_{i = 1}^{N} {\sum }_{j > i}^{N} {W}_{ij} {x}_{i} {x}_{j} - {\sum }_{i = 1}^{N} {b}_{i} {x}_{i} \qquad ( 1 )$$

A first term on a right side is obtained by integrating products of values (0 or 1) of two state variables and a weight value (representing strength of correlation between the two state variables) for all combinations of N state variables of the Ising model with neither an omission nor an overlap. A state variable with an identification number i is represented by xᵢ, a state variable with an identification number j is represented by xⱼ, and a weight value indicating magnitude of correlation between the state variables with the identification numbers i and j is represented by Wᵢⱼ. A second term on the right side is obtained by summing up products of a bias coefficient and a state variable for each identification number. A bias coefficient for the identification number i is represented by bᵢ.

Furthermore, an energy change amount (ΔEᵢ) associated with a change in the value of xᵢ is represented by the following Expression (2).

$$[ Expression 2 ]$$

$$Δ {E}_{i} = - Δ {x}_{i} ( {\sum }_{j}^{N} {W}_{ij} {x}_{j} + {b}_{i} ) = - Δ {x}_{i} {h}_{i} \qquad ( 2 )$$

In Expression (2), when xᵢ changes from 1 to 0, Δxᵢ becomes −1, and when the state variable xᵢ changes from 0 to 1, Δxᵢ becomes 1. Note that hᵢ is called a local field, and ΔEᵢ is obtained by multiplying hᵢ by a sign (+1 or −1) according to Δxᵢ. Thus, hᵢ may also be said to be a variable that represents the energy change amount, or a variable that determines the energy change amount.

Then, for example, processing of updating the value of xᵢ with an acceptance probability that may be represented as exp(−βΔEᵢ) (β is a reciprocal of a parameter representing temperature) to generate a state transition, and also updating the local field is repeated.

Incidentally, some discrete optimization problems have a constraint condition that needs to be satisfied by a solution. For example, a knapsack problem, which is one of the discrete optimization problems, has a constraint condition that a total capacity of luggage that may be packed in a knapsack is equal to or smaller than a capacity of the knapsack. Such a constraint condition is called an inequality constraint, and may be represented by a constraint term having a value depending on whether or not the constraint condition is violated. The constraint conditions include not only the inequality constraint but also an equality constraint, an absolute value constraint, and the like.

Total energy (H(x)) including the constraint term may be represented by the following Expression (3).

$$[ Expression 3 ]$$

$$H ( x ) = - \frac{1}{2} {\sum }_{i ∈ D} {\sum }_{j ∈ D} {W}_{ij} {x}_{i} {x}_{j} - {\sum }_{i ∈ D} {b}_{i} {x}_{i} + {\sum }_{k ∈ A} {λ}_{k} g ( {h}_{k} ) \qquad ( 3 )$$

In Expression (3), the sum of a first term and a second term on a right side represents energy corresponding to E(x) in Expression (1), and a third term on the right side represents overall magnitude (energy) of the constraint term. Furthermore, D represents a set of identification numbers of the state variables, k represents an identification number of the constraint term, and A represents a set of identification numbers of the constraint terms. Furthermore, λₖ is a predetermined positive coefficient for the constraint term with the identification number k.

In a case where the constraint condition is the inequality constraint, g(hₖ) in Expression (3) may be represented by the following Expression (4).

$$[ Expression 4 ]$$

$$g ( {h}_{k} ) = max [ 0 , {h}_{k} ] , {h}_{k} = {R}_{k} - {U}_{k} = {\sum }_{i ∈ D} {W}_{ki} {x}_{i} - {U}_{k} \qquad ( 4 )$$

In Expression (4), max[0, hₖ] is a function that outputs the larger value of 0 and hₖ. Furthermore, Rₖ represents a consumption amount (also called resource amount) of the constraint term with the identification number k, and Uₖ represents an upper limit of the resource amount. Wₖᵢ is a coefficient (weight value) indicating a weight of xᵢ in the inequality constraint with the identification number k.

In Expression (3), an energy change amount (ΔHⱼ) associated with a change in the value of xⱼ is represented by the following Expression (5).

$$[ Expression 5 ]$$

$$Δ {H}_{j} = - {h}_{j} Δ {x}_{j} + {\sum }_{k ∈ A} {λ}_{k} ( g ( {h}_{k} + {W}_{kj} Δ {x}_{j} ) - g ( {h}_{k} ) ) \qquad ( 5 )$$

In the case where the constraint condition is the inequality constraint, the energy change amount (ΔHⱼ) associated with the change in the value of xⱼ may be represented by the following Expression (6) instead of Expression (5).

$$[ Expression 6 ]$$

$$Δ {H}_{j} = - \text{} {h}_{j} Δ {x}_{j} + {\sum }_{i = 1}^{M} {λ}_{i} ( max [ 0 , {h}_{i} + {a}_{ij} Δ {x}_{j} - {C}_{ui} ] - max [ 0 , {h}_{i} - {C}_{ui} ] \qquad ( 6 )$$

In Expression (6), aᵢⱼ is a coefficient indicating a weight of xⱼ in the inequality constraint with the identification number i, and corresponds to Wₖᵢ described above. Cᵤᵢ is an upper limit value in the inequality constraint with the identification number i, and corresponds to Uₖ described above. M represents the number of constraint terms.

The acceptance probability of accepting a change in the value of xⱼ may be represented as Aⱼ=min[1, exp(−βΔHⱼ)]. A function that outputs the smaller value of 1 and exp(−βΔHⱼJ) is represented by min[1, exp(−βΔHⱼ)].

Expression (3) is not a function in a quadratic form like Expression (1), but a discontinuous function in a linear form. Since before, there has been proposed a technology for transforming a discontinuous function in a linear form into a quadratic form so that an Ising device may handle an inequality constraint. However, in the case of calculating a discrete optimization problem by using a constraint term of the inequality constraint transformed into the quadratic form, it is sometimes difficult to solve the problem with the Ising device because processing becomes complicated, for example.

Thus, since before, there has been proposed a technology for solving a problem with an Ising device by using the constraint term of the inequality constraint as described above as it is in the linear form.

Japanese Laid-open Patent Publication No. 2020-201598 and Japanese Laid-open Patent Publication No. 2020-204928 are disclosed as related art.

### SUMMARY

### Technical Problem

In the known technology for solving a problem by using the constraint term of the inequality constraint as it is in the linear form, calculation using all coefficients related to each constraint term (aᵢⱼ in the example of Expression (6) described above) is performed when calculation of ΔHⱼ associated with a change in a value of a state variable is performed.

There may be equal to or greater than 1000 coefficients related to each constraint term. In the known technology, when the calculation of ΔHⱼ is performed, all the coefficients are read from a memory to perform addition processing. Thus, a calculation amount may become large.

In one aspect, an embodiment aims to provide a data processing apparatus, a program, and a data processing method capable of reducing a calculation amount of a discrete optimization problem with a constraint condition.

### Solution to Problem

According to an aspect of the embodiments, a data processing apparatus includes one or more memories; and one or more processors coupled to the one or more memories and the one or more processors configured to: search for a combination of values of a plurality of state variables that minimizes or maximizes a value of an Ising-type evaluation function that includes the plurality of state variables, store total energy that is a sum of a plurality of constraint terms and the value of the evaluation function, the values of the plurality of state variables, a first weight value between each of the plurality of state variables, a second weight value between one of the plurality of state variables and each of a plurality of constraint conditions, a first local field, and a second local field in the one or more memories, the plurality of constraint terms including values that correspond to whether each of the plurality of constraint conditions is violated, the first local field indicating a first change amount of the total energy when a value of each of the plurality of state variables changes, the second local field being used to specify a constraint violation amount for each of the plurality of the constraint conditions, and repeat determining whether to permit a change in a value of a first state variable among the plurality of state variables based on the first local field, and when the change in the value of the first state variable is permitted, updating the first local field based on the first weight value, updating the second local field that corresponds to a constraint condition in which the second weight value with the first state variable is non-zero based on the second weight value, and updating the first local field based on the second local field before the updating and the second local field after the updating.

The object and advantages of the invention will be realized and attained by means of the elements and combinations particularly pointed out in the claims.

It is to be understood that both the foregoing general description and the following detailed description are exemplary and explanatory and are not restrictive of the invention.

### Advantageous Effects of Invention

In one aspect, an embodiment may reduce a calculation amount of a discrete optimization problem with a constraint condition.

### BRIEF DESCRIPTION OF DRAWINGS

FIG. 1 is a diagram illustrating an example of a data processing apparatus and a data processing method of a first embodiment;

FIG. 2 is a diagram illustrating an example of a change amount of a value of a penalty function due to a change in a value of a state variable;

FIG. 3 is a diagram illustrating an example of updating local fields in a case where a value of xⱼ changes;

FIG. 4 is a diagram illustrating a procedure of an example of updating the local fields;

FIG. 5 is a diagram illustrating a data processing apparatus of a first comparative example;

FIG. 6 is a diagram illustrating a data processing apparatus of a second comparative example;

FIG. 7 is a diagram illustrating an example of updating local fields in a case where a value of xₖ changes in the second comparative example and an example of updating the local fields in a case where a value of hₖ changes in the first embodiment;

FIG. 8 is a diagram illustrating examples of occurrence of a prediction error in the data processing apparatus of the second comparative example;

FIG. 9 is a diagram illustrating examples of the penalty function that may be used;

FIG. 10 is a diagram illustrating an example of a constraint term;

FIG. 11 is a block diagram illustrating a hardware example of a data processing apparatus of a second embodiment;

FIG. 12 is a block diagram illustrating a functional example of the data processing apparatus;

FIG. 13 is a diagram illustrating an operation example of the data processing apparatus of the second embodiment;

FIG. 14 is a diagram illustrating a circuit example of an hₖ contribution amount calculation unit;

FIG. 15 is a diagram illustrating a first calculation example of Δg;

FIG. 16 is a diagram illustrating a second calculation example of Δg;

FIG. 17 is a diagram illustrating an example of Δg generation circuits that generate Δg by combining a plurality of the penalty functions;

FIG. 18 is a flowchart illustrating a flow of an example of the data processing method;

FIG. 19 is a flowchart illustrating a flow of an example of local field update processing; and

FIG. 20 is a diagram illustrating another example of the data processing apparatus.

### DESCRIPTION OF EMBODIMENTS

Hereinafter, modes for carrying out embodiments will be described with reference to the drawings.

### First Embodiment

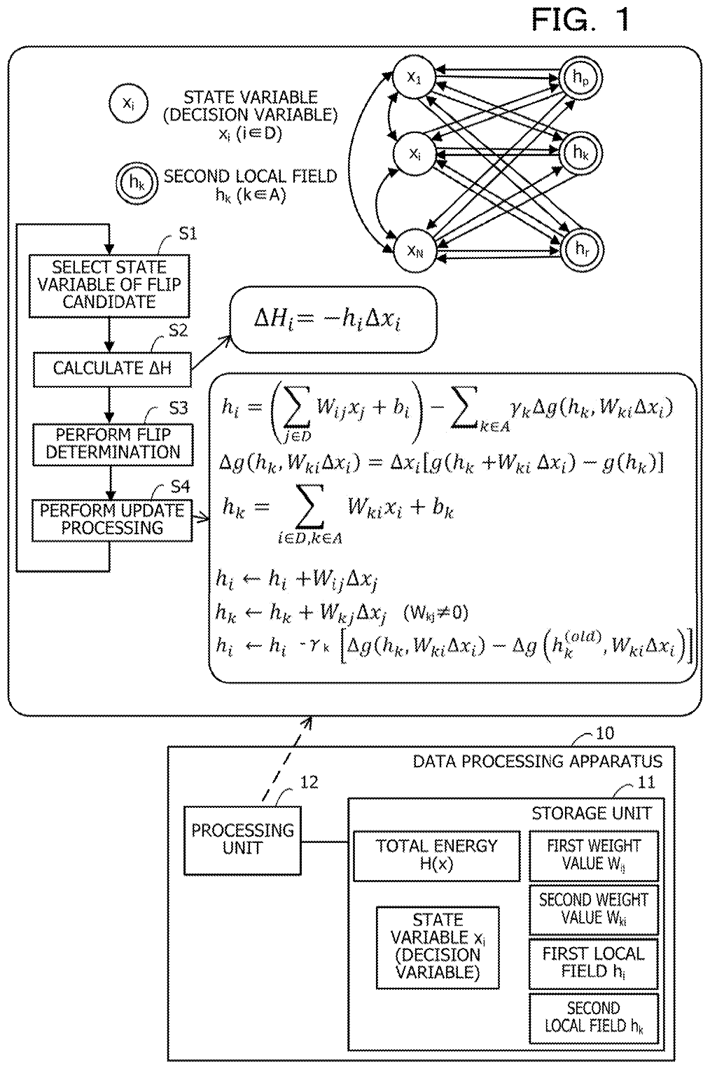

FIG. 1 is a diagram illustrating an example of a data processing apparatus and a data processing method of a first embodiment.

A data processing apparatus 10 of the first embodiment includes a storage unit 11 and a processing unit 12.

The storage unit 11 is, for example, a volatile storage device that is an electronic circuit such as a dynamic random access memory (DRAM), or a non-volatile storage device that is an electronic circuit such as a hard disk drive (HDD) or a flash memory. The storage unit 11 may include an electronic circuit such as a static random access memory (SRAM) register.

The storage unit 11 stores H(x), a plurality of (hereinafter N) values of state variables (xᵢ), a first weight value (Wᵢⱼ described above) between each of the N xᵢ's, and a second weight value (Wₖᵢ) between any one of the N xᵢ's and each of M constraint conditions. Note that the storage unit 11 does not need to store the second weight value (second weight value with a value of 0) related to a state variable that does not affect any one of the M constraint conditions.

An identification number representing any one of the N xᵢ's is represented by i, and an identification number representing any one of the M constraint terms (or constraint conditions) is represented by k.

Moreover, the storage unit 11 stores a first local field (hᵢ) that represents a change amount (ΔHᵢ) of H(x) in a case where each of the values of the N xᵢ's changes, and a second local field (hₖ) used to specify a constraint violation amount for each of the M constraint conditions. Note that the state variable may also be called a decision variable. Since each second local field corresponds to each constraint term, the second weight value may also be said to be a weight value between the state variable and the second local field.

In FIG. 1, correlation between each of a plurality of state variables (x₁, xᵢ, and x_{N} in the example of FIG. 1), and correlation between each of the plurality of state variables and a plurality of second local fields (hₚ, hₖ, and hᵣ in the example of FIG. 1) are indicated by arrows. Magnitude of the correlation corresponds to the first weight value or the second weight value.

H(x) stored in the storage unit 11 may be represented as H(x)=E(x)+P(x). E(x) is the sum of the first term and the second term on the right side of the Expression (3) described above.

In the following, it is assumed that total energy P(x) of the M constraint terms corresponding to the M constraint conditions is represented by Expression (7).

$$[ Expression 7 ]$$

$$P ( x ) = {\sum }_{k ∈ A} {γ}_{k} g ( {h}_{k} ) \qquad ( 7 )$$

A proportional coefficient related to a constraint term with the identification number=k is represented by γₖ, and γₖ represents a weight of the constraint term. A different value may be used for γₖ for each constraint term. For example, g(hₖ) may be a Max function as represented by Expression (4), or may be another function (for example, a step function or the like). Hereinafter, g(hₖ) is called a penalty function.

The second local field (hₖ) may be represented by the following Expression (8).

$$[ Expression 8 ]$$

$${h}_{k} = {\sum }_{i ∈ D , k ∈ A} {W}_{ki} {x}_{i} + {b}_{k} \qquad ( 8 )$$

In Expression (8), bₖ is a coefficient related to a constraint condition with the identification number=k. In a case where the constraint condition with the identification number=k is an inequality constraint, a first term on a right side of Expression (8) corresponds to Rₖ in Expression (4) described above, and +bₖ corresponds to −Uₖ in Expression (4). Thus, as described above, hₖ may be said to be a variable used to specify a difference between Rₖ and Uₖ, for example, a constraint violation amount.

Note that ΔHᵢ in a case where a value of a certain state variable (xᵢ) changes may be represented by the following Expression (9) using the penalty function.

$$[ Expression 9 ]$$

$$Δ {H}_{i} = - ( {\sum }_{j ∈ D} {W}_{ij} {x}_{j} + {b}_{i} ) Δ {x}_{i} + {\sum }_{k ∈ A} {γ}_{k} ( g ( {h}_{k} + {W}_{ki} Δ {x}_{i} ) - g ( {h}_{k} ) ) \qquad ( 9 )$$

In Expression (9), g(hₖ+WₖᵢΔxᵢ)−g(hₖ) represents a change amount of a value of the penalty function (which may also be called a change amount of the constraint term) in a case where the value of the certain state variable (xᵢ) changes.

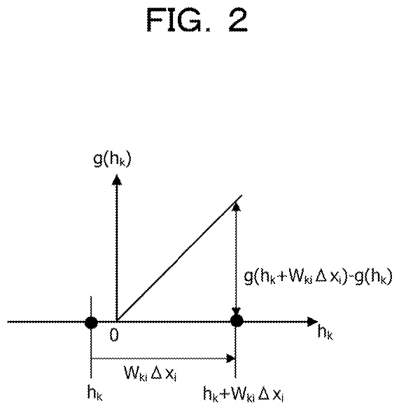

FIG. 2 is a diagram illustrating an example of the change amount of the value of the penalty function due to the change in the value of the state variable. A vertical axis represents magnitude of g(hₖ), and a horizontal axis represents hₖ.

In FIG. 2, g(hₖ)=max[0, hₖ] is used as an example of the penalty function. When hₖ changes to hₖ+WₖᵢΔxᵢ as the value of xᵢ changes, the change amount of the value of the penalty function is represented as g(hₖ+WₖᵢΔxᵢ)−g(hₖ).

In the data processing apparatus 10 of the present embodiment, the first local field (hᵢ) that reflects not only a change amount of E(x) associated with the change in the value of xᵢ but also a change amount of P(x) is used. Such hᵢ may be represented by the following Expression (10).

$$[ Expression 10 ]$$

$${h}_{i} = ( {\sum }_{j ∈ D} {W}_{ij} {x}_{j} + {b}_{i} ) - {\sum }_{k ∈ A} {γ}_{k} Δ g ( {h}_{k} , {W}_{ki} Δ {x}_{i} ) \qquad ( 10 )$$

In Expression (10), Δg(hₖ, WₖᵢΔxᵢ) is represented by the following Expression (11), and is an amount that may be calculated from xᵢ, hₖ, and Wₖᵢ.

[Expression 11]

Δg(hₖ,WₖᵢΔxᵢ)=Δxᵢ[g(hₖ+WₖᵢΔxᵢ)−g(hₖ)] (11)

By using hᵢ as in Expression (10), ΔHᵢ is represented as ΔHᵢ=−hᵢΔxᵢ.

The storage unit 11 may further store a bias coefficient (bᵢ), the proportional coefficient (γₖ), and the coefficient (bₖ) related to the constraint condition. Furthermore, the storage unit 11 may store various types of data such as calculation conditions when the processing unit 12 executes the data processing method to be described later. Furthermore, in a case where the processing unit 12 executes a part or all of processing of the data processing method to be described later by software, the storage unit 11 stores a program for executing the processing.

The processing unit 12 of FIG. 1 may be implemented by, for example, a processor that is hardware such as a central processing unit (CPU), a graphics processing unit (GPU), or a digital signal processor (DSP). Furthermore, the processing unit 12 may be implemented by an electronic circuit such as an application specific integrated circuit (ASIC) or a field programmable gate array (FPGA).

For example, the processing unit 12 searches for a state where E(x) is minimized. The state where a minimum value of local minimum values of E(x) is reached is to be an optimum solution. Note that the processing unit 12 may also search for a state where the value of E(x) is maximized by changing the signs of E(x) and P(x) (in this case, the state where the maximum value is reached is to be the optimum solution).

In FIG. 1, a flow of an example of processing by the processing unit 12 is illustrated.

Note that, here, it is assumed that values based on initial values of x₁ to x_{N} are stored in the storage unit 11 as H(x), hᵢ, hₖ, and xₖ.

The processing unit 12 selects a state variable of a candidate (hereinafter referred to as a flip candidate) whose value is to be changed from the N state variables (Step S1). The processing unit 12 selects the state variable of the flip candidate at random or in a predetermined order, for example.

Then, the processing unit 12 calculates ΔH in a case where a value of the selected state variable changes (Step S2). For example, in a case where xᵢ is selected, ΔHᵢ may be calculated by an expression ΔHᵢ=−hᵢΔxᵢ based on hᵢ as described above.

Next, the processing unit 12 determines whether or not to permit a change in the value of the state variable of the flip candidate (whether or not flip is permissible) based on a result of comparison between ΔH and a predetermined value (Step S3). Hereinafter, this determination processing will be referred to as flip determination processing.

The predetermined value is, for example, a noise value obtained based on a random number and a value of a temperature parameter. For example, log(rand)×T, log( ) is natural logarithm, which is an example of a noise value obtained based on a uniform random number (rand) equal to or greater than 0 and equal to or smaller than 1 and a temperature parameter (T), may be used as the predetermined value. In this case, in a case where −ΔHᵢ≥log(rand)×T, the processing unit 12 determines that the change in the value of the state variable of the flip candidate is permitted (flip is permissible).

In a case where it is determined that flip is permissible, the processing unit 12 performs update processing (Step S4).

For example, in a case where it is determined that flip is permissible for xⱼ, the processing unit 12 updates hᵢ by adding Δhᵢ=WᵢⱼΔxⱼ to the original hᵢ for each of the N state variables. Note that, in a case where i=j, Wᵢᵢ=0 and hᵢ does not change, so updating is unnecessary. Furthermore, in a case where it is determined that the flip is permissible for xⱼ, the processing unit 12 updates hₖ by adding Δhₖ=WₖⱼΔxⱼ to hₖ whose second weight value (Wₖⱼ) with xⱼ is non-zero.

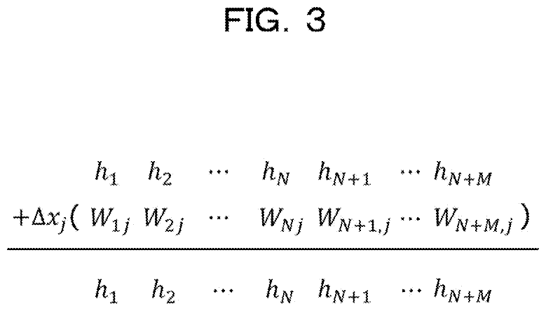

FIG. 3 is a diagram illustrating an example of updating the local fields in a case where a value of xⱼ changes. In the example of FIG. 3, the first local field (hᵢ) is indicated by h₁ to h_{N} and the second local field (hₖ) is indicated by h_{N+1} to h_{N+M}. Such calculation may be performed by parallel calculation with a degree of parallelism of N+M.

Moreover, the processing unit 12 further updates hᵢ according to the following Expression (12) based on hₖ before and after updating.

[Expression 12]

hᵢ←hᵢ−γₖ[Δg(hₖ,WₖᵢΔxᵢ)−Δg(hₖ^{(old)},WₖᵢΔxᵢ)] (12)

In Expression (12), hₖ^{(old)} represents hₖ before updating. Note that, in a case where i=j, hᵢ does not change, so updating is unnecessary.

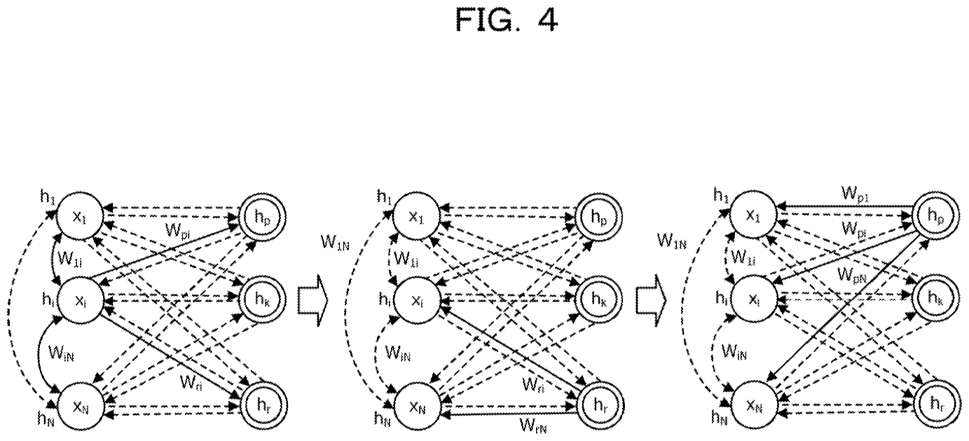

FIG. 4 is a diagram illustrating a procedure of an example of updating the local fields.

The state variables are represented by x₁, xᵢ, and x_{N}, and the second local fields are represented by hₚ, hₖ, and hᵣ.

In a case where the value of xᵢ changes among the state variables x₁, xᵢ, and x_{N}, the first local field corresponding to the state variable whose first weight value with xᵢ is non-zero, and the second local field whose second weight value with xᵢ is non-zero are updated. For example, h₁ corresponding to x₁ whose first weight value (W₁ᵢ) with xᵢ is non-zero is updated by adding Δh₁=W₁ᵢΔxᵢ, and h_{N} corresponding to x_{N} whose first weight value (W_{iN}) with xᵢ is non-zero is updated by adding Δh_{N}=W_{iN}Δxᵢ. Furthermore, hₚ whose second weight value (Wₚᵢ) with xᵢ is non-zero is updated by adding Δhₚ=WₚᵢΔxᵢ, and hᵣ whose second weight value (Wᵣᵢ) with xᵢ is non-zero is updated by adding Δhᵣ=WᵣᵢΔxᵢ.

Next, the first local field corresponding to the state variable whose second weight value with the second local field whose value changes is non-zero is updated based on Expression (12). For example, hᵢ and h_{N} corresponding to xᵢ and x_{N}, whose second weight values (Wᵣᵢ and W_{rN}) with hᵣ are non-zero, are updated based on Expression (12). Moreover, h₁, hᵢ, and h_{N} corresponding to x₁, xᵢ, and x_{N}, whose second weight values (Wₚ₁, Wₚᵢ, and W_{pN}) with hₚ are non-zero, are updated based on Expression (12).

In the processing of Step S4, the processing unit 12 further updates H(x) by adding ΔH to the original H(x), and changes (flips) the value of the state variable (for example, xⱼ) for which it is determined that flip is permissible.

The processing unit 12 repeats the Steps S1 to S4 above.

Note that, in the description above, an example is indicated in which one state variable of the flip candidate is selected from among the N state variables, and the processing of Steps S2 to S4 is performed. However, the processing of Steps S2 and S3 may be performed in parallel for a plurality of (for example, all the N) state variables. In that case, when there is a plurality of state variables whose values are permitted to change, the processing unit 12 selects a state variable whose value is to be changed at random or according to a predetermined rule.

In a case where a simulated annealing method is performed, for example, the processing unit 12 reduces a value of the temperature parameter (T) described above according to a predetermined temperature parameter change schedule each time when flip determination processing for a state variable is repeated a predetermined number of times. Then, the processing unit 12 outputs a state obtained in a case where the flip determination processing is repeated the predetermined number of times (or in a case where a predetermined T is reached) as a calculation result of a discrete optimization problem. Note that the processing unit 12 may cause the storage unit 11 to hold total energy and a state in a case where the energy becomes the minimum until then. In that case, the processing unit 12 may output a state corresponding to the minimum energy stored after the flip determination processing is repeated the predetermined number of times as a calculation result.

In a case where the processing unit 12 performs a replica exchange method, the processing unit 12 repeats the processing of Steps S1 to S4 described above for each of a plurality of replicas to which each different T value is set. Then, the processing unit 12 exchanges the replica each time when the flip determination processing is repeated the predetermined number of times. For example, the processing unit 12 selects two replicas having adjacent T values and exchanges the values of the respective state variables and the values of the respective auxiliary variables between the selected two replicas at a predetermined exchange probability based on an energy difference or a T value difference between the replicas. Note that the T values may be exchanged between the two replicas instead of the values of the respective state variables and the values of the respective auxiliary variables. Alternatively, the processing unit 12 holds the total energy and the state in a case where the energy becomes the minimum until then. Then, the processing unit 12 outputs, as a calculation result, a state corresponding to the minimum energy in all the replicas, among the minimum energy stored after the flip determination processing described above is repeated the predetermined number of times in each replica.

By using the replica exchange method, the state changes even on a low temperature side (replica on a side where the T value is small) where the state hardly changes, and possibility of finding a good solution in a short time increases.

According to the data processing apparatus 10 and the data processing method as described above, as illustrated in FIG. 3, hᵢ and hₖ may be updated with the degree of parallelism of N+M, and no update is performed for hₖ whose second weight value with the state variable whose value is permitted to change is 0. For example, only hₖ used to specify a constraint violation amount for a constraint condition affected by the change in the state variable is updated. Furthermore, for hₖ that is not updated, a value thereof does not change. Thus, hᵢ is not further updated by Expression (12) using that hₖ (see FIG. 4 described above).

With this configuration, a calculation amount for the update processing may be reduced.

Furthermore, as the first local field (hᵢ), a value reflecting not only the change amount of E(x) associated with the change in the value of xᵢ but also the change amount of P(x) (corresponding to g(hₖ+WₖᵢΔxᵢ)−g(hₖ) of FIG. 2), the flip determination may be made based on more accurate ΔH. Thus, a solution performance may be improved.

### COMPARATIVE EXAMPLES

Hereinafter, data processing apparatuses of two comparative examples will be described.

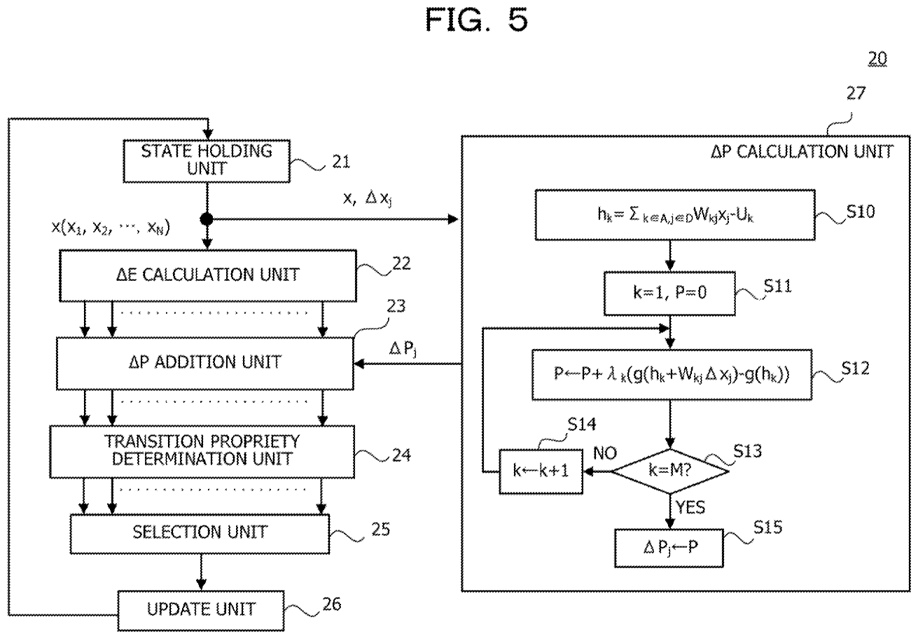

FIG. 5 is a diagram illustrating a data processing apparatus of a first comparative example.

A data processing apparatus 20 of the first comparative example performs, as in the known technology, calculation using all coefficients related to each constraint term (Wₖⱼ in the example of Expression (5) and aᵢⱼ in the example of Expression (6) described above) when performing calculation of ΔH associated with a change in a value of a state variable.

The data processing apparatus 20 of the comparative example includes a state holding unit 21, a ΔE calculation unit 22, a ΔP addition unit 23, a transition propriety determination unit 24, a selection unit 25, an update unit 26, and a ΔP calculation unit 27.

The state holding unit 21 holds a state x (x₁ to x_{N}) and outputs x. Furthermore, the state holding unit 21 outputs Δxⱼ.

The ΔE calculation unit 22 calculates ΔEⱼ (first term on a right side of Expression (5)) in a case where each of x₁ to x_{N} changes.

The ΔP addition unit 23 adds ΔPⱼ (second term on the right side of Expression (5)) to ΔEⱼ. With this configuration, ΔHⱼ in Expression (5) is calculated.

The transition propriety determination unit 24 performs flip determination processing for each of x₁ to x_{N} based on a result of comparison between ΔHⱼ and the predetermined value described above.

The selection unit 25 selects, in a case where there is a plurality of state variables for which it is determined that flip is permissible, any one of the state variables.

The update unit 26 sends an identification number of a state variable for which it is determined that flip is permissible to the state holding unit 21 to change a value of the state variable. Furthermore, the update unit 26 updates hⱼ and H.

The ΔP calculation unit 27 calculates ΔPⱼ in a case where each of x₁ to x_{N} changes. The calculation of ΔPⱼ is performed as follows, for example.

The ΔP calculation unit 27 calculates hₖ (Step S10). In the example of FIG. 5, hₖ is calculated using j instead of i in Expression (4).

Next, the ΔP calculation unit 27 sets k=1 and P=0 (Step S11), and newly sets P as a result of calculating P+λₖ(g(hₖ+WₖⱼΔxⱼ)−g(hₖ)) based on the second term on the right side of Expression (5) (Step S12).

Then, the ΔP calculation unit 27 determines whether or not k=M holds (Step S13). In a case where it is determined that k=M does not hold, the ΔP calculation unit 27 sets k to k+1 (Step S14), and repeats the processing from Step S12.

In a case where it is determined that k=M holds, the ΔP calculation unit 27 outputs P as ΔPⱼ (Step S15).

In the processing as described above, the processing of Step S12 is repeated M times to calculate ΔPⱼ for each of x₁ to x_{N}. For example, reading of Wₖⱼ and addition processing are performed M times. Thus, a calculation amount proportional to N×M is needed to calculate N ΔPⱼ's, and the calculation amount is large. Furthermore, a data transfer amount for the reading is large. This is because the M Wₖⱼ's are serially read in calculating one ΔPⱼ.

In order to reduce the calculation amount, it is also conceivable to use the following data processing apparatus.

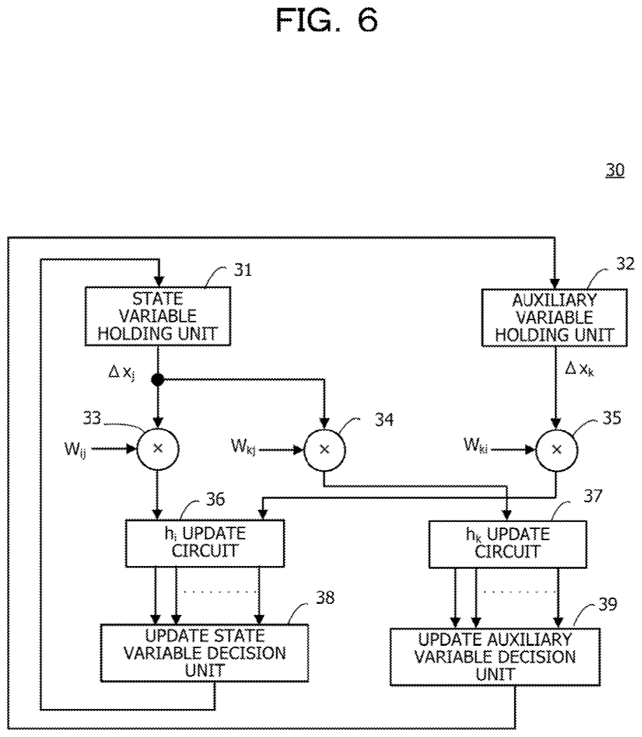

FIG. 6 is a diagram illustrating a data processing apparatus of a second comparative example.

A data processing apparatus 30 of the second comparative example includes a state variable holding unit 31, an auxiliary variable holding unit 32, multipliers 33, 34, and 35, an hᵢ update circuit 36, an hₖ update circuit 37, an update state variable decision unit 38, and an update auxiliary variable decision unit 39.

The state variable holding unit 31 holds N state variables (xᵢ). Furthermore, the state variable holding unit 31 outputs a change amount (Δxⱼ) of xⱼ of a flip candidate.

The auxiliary variable holding unit 32 holds M auxiliary variables (xₖ). A variable that becomes 0 in a case where the constraint condition with the identification number=k is satisfied and that becomes 1 in a case where the constraint condition with the identification number=k is not satisfied is represented by xₖ. Furthermore, the auxiliary variable holding unit 32 outputs a change amount (Δxₖ) of xₖ of a flip candidate.

In a case where such auxiliary variables are used, H(x) may be represented by the following Expression (13), for example.

$$[ Expression 13 ]$$

$$\begin{matrix}H ( x ) = E ( x ) + P ( x ) \\ = E ( x ) + {\sum }_{k ∈ A} {λ}_{k} ( {\sum }_{i ∈ D} {W}_{ki} {x}_{i} - {U}_{k} ) {x}_{k}\end{matrix} \qquad ( 13 )$$

Furthermore, in the data processing apparatus 30 of the second comparative example, hᵢ may be represented by the following Expression (14).

$$[ Expression 14 ]$$

$${h}_{i} = {\sum }_{j ∈ D} {W}_{ij} {x}_{j} + {b}_{i} - {\sum }_{k ∈ A} {λ}_{k} {W}_{ki} {x}_{k} \qquad ( 14 )$$

Furthermore, hₖ may be represented by the following Expression (15).

$$[ Expression 15 ]$$

$${h}_{k} = {\sum }_{i ∈ D , k ∈ A} {W}_{ki} {x}_{i} - {U}_{k} \qquad ( 15 )$$

Note that Expression (15) is the same as Expression (8) when it is assumed that −Uₖ=bₖ.

The multiplier 33 outputs a product of Δxⱼ and Wᵢⱼ, which is a change amount of hᵢ as indicated in Expression (14) in a case where a value of xⱼ of the flip candidate changes.

The multiplier 34 outputs a product of Δxⱼ and Wₖⱼ, which is a change amount of hₖ as indicated in Expression (15) in a case where the value of xⱼ of the flip candidate changes.

The multiplier 35 outputs a product of Δxₖ and Wₖᵢ, which is a change amount of hᵢ as indicated in Expression (14) in a case where a value of xₖ of the flip candidate changes.

The hᵢ update circuit 36 updates hᵢ by adding WᵢⱼΔxⱼ to the original hᵢ in a case where the value of xⱼ of the flip candidate changes. Furthermore, the hᵢ update circuit 36 updates hᵢ by adding −λₖWₖᵢΔxₖ to the original hᵢ in a case where the value of xₖ of the flip candidate changes.

The hₖ update circuit 37 updates hₖ by adding WₖⱼΔxⱼ to the original hₖ in a case where the value of xⱼ of the flip candidate changes.

The update state variable decision unit 38 calculates ΔH=−hⱼΔxⱼ based on hⱼ, which is the first local field for xⱼ of the flip candidate. Then, the update state variable decision unit 38 decides whether or not to change the value of xⱼ based on a result of comparison between ΔH and a predetermined value, and in a case where it is decided to change the value of xⱼ, changes the value of xⱼ held in the state variable holding unit 31.

The update auxiliary variable decision unit 39 calculates ΔH=+λₖhₖΔxₖ based on hₖ, which is the second local field for xₖ of the flip candidate. Then, the update auxiliary variable decision unit 39 decides whether or not to change the value of xₖ based on a result of comparison between ΔH and a predetermined value, and in a case where it is decided to change the value of xₖ, changes the value of xₖ held in the auxiliary variable holding unit 32.

In such a data processing apparatus 30, in a case where the value of the auxiliary variable (xₖ) representing whether or not a certain constraint condition is violated is permitted to change, hᵢ is updated based on the N Wₖᵢ's. With this configuration, Wₖᵢ's related to all the M constraint terms do not have to be read, and the number of times the addition processing (processing of adding Δhᵢ=−λₖWₖᵢΔxₖ to the original hᵢ) is performed is suppressed, and a calculation amount for the update processing may be reduced.

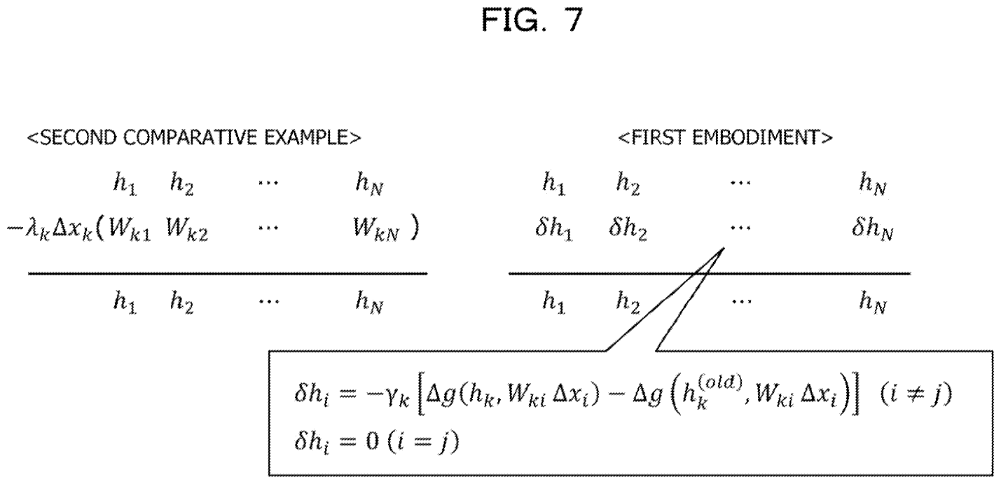

FIG. 7 is a diagram illustrating an example of updating the local fields in a case where the value of xₖ changes in the second comparative example and an example of updating the local fields in a case where the value of hₖ changes in the first embodiment.

In the data processing apparatus 30 of the second comparative example, in a case where the value of xₖ changes, updating is performed by adding −λₖΔxₖWₖᵢ (Wₖ₁ to W_{kN}) to the N hᵢ's (h₁ to h_{N}). On the other hand, in the data processing apparatus 10 of the first embodiment, in a case where the value of hₖ changes, updating is performed by adding δhᵢ (δh₁ to δh_{N}) to the N hᵢ's (h₁ to h_{N}). In Expression (12), −γₖ[Δg(hₖ, WₖᵢΔxᵢ)−Δg(hₖ^{(old)}, WₖᵢΔxᵢ)] is δhᵢ.

In the data processing apparatus 30 of the second comparative example, at the time of determining whether or not to change the value of the state variable of the flip candidate, the change amount of the constraint term associated with the change is not taken into consideration. Thus, the following prediction error may occur until H(x) is updated by ΔH=+λₖhₖΔxₖ as the value of the auxiliary variable changes.

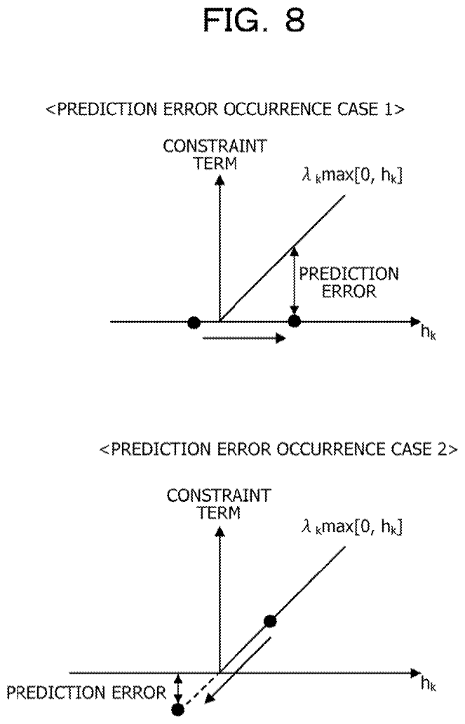

FIG. 8 is a diagram illustrating examples of occurrence of a prediction error in the data processing apparatus of the second comparative example. A vertical axis represents magnitude of a constraint term, and a horizontal axis represents hₖ. In FIG. 8, the constraint term of an inequality constraint is represented by λₖmax[0, hₖ].

In a prediction error occurrence case 1, a prediction error that occurs in a case where the inequality constraint changes from a satisfied state to a violated state is indicated. In a prediction error occurrence case 2, a prediction error that occurs in a case where the inequality constraint changes from a violated state to a satisfied state is indicated.

In either case, the prediction error as indicated in FIG. 8 may occur.

Thus, it may become difficult to improve a solution performance for an inequality constraint problem with a high degree of difficulty. Furthermore, in the data processing apparatus 30 of the second comparative example, the penalty functions that may be used are limited to rectified linear unit (ReLU) type functions.

On the other hand, in the data processing apparatus 10 of the first embodiment, as in Expression (10) described above, a value reflecting not only the change amount of E(x) associated with the change in the value of xᵢ but also the change amount of P(x) (corresponding to g(hₖ+WₖᵢΔxᵢ)−g(hₖ) of FIG. 2) may be used as hᵢ. Thus, the flip determination may be made based on more accurate ΔHᵢ. With this configuration, a solution performance may be improved.

Furthermore, the penalty functions that may be handled by the data processing apparatus 10 of the first embodiment are not limited to the ReLU type functions.

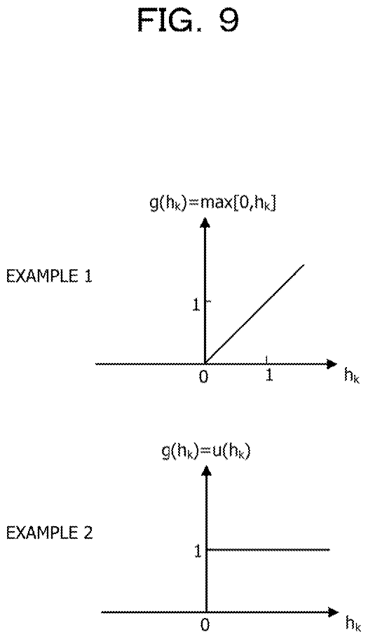

FIG. 9 is a diagram illustrating examples of the penalty function that may be used.

In Example 1, max[0, hₖ], which is the ReLU type function, is indicated as the penalty function g(hₖ).

In Example 2, a step function u(hₖ) is indicated as the penalty function g(hₖ).

Furthermore, a constraint term that combines each of the two penalty functions described above may also be used.

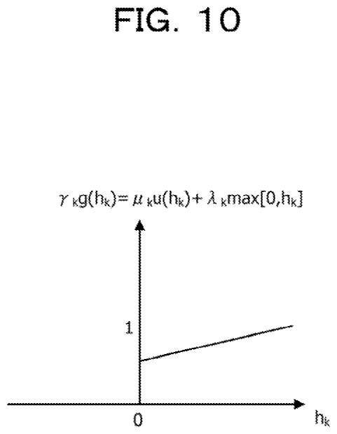

FIG. 10 is a diagram illustrating an example of the constraint term.

In FIG. 10, γₖg(hₖ)=μₖu(hₖ)+λₖmax[0, hₖ], which is the sum of a function obtained by weighting the step function u(hₖ) by a proportional coefficient μₖ and a function obtained by weighting max[0, hₖ] by a proportional coefficient λₖ, is represented as an example of the constraint term.

Note that the penalty functions that may be used are not limited to the examples described above. However, since the calculation of Expression (12) is performed when hᵢ is updated, it is desirable that the penalty function be a function that is relatively easy to calculate.

### Second Embodiment

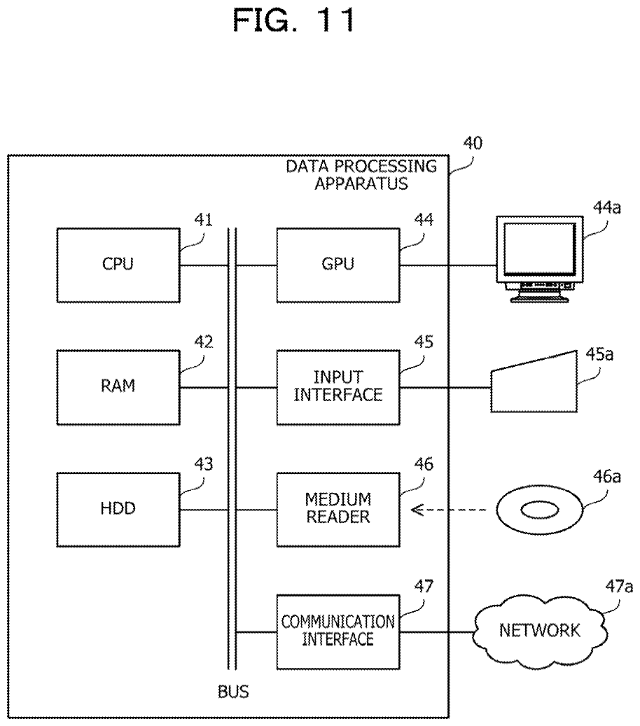

FIG. 11 is a block diagram illustrating a hardware example of a data processing apparatus of a second embodiment.

A data processing apparatus 40 is, for example, a computer, and includes a CPU 41, a random access memory (RAM) 42, an HDD 43, a GPU 44, an input interface 45, a medium reader 46, and a communication interface 47. The units described above are connected to a bus.

The CPU 41 is a processor including an arithmetic circuit that executes a command of a program. The CPU 41 loads at least a part of a program and data stored in the HDD 43 into the RAM 42 to execute the program. Note that the CPU 41 may include a plurality of processor cores, the data processing apparatus 40 may include a plurality of processors, and processing to be described below may be executed in parallel by using the plurality of processors or processor cores. Furthermore, a set of a plurality of processors (multiprocessor) may be called a “processor”.

The RAM 42 is a volatile semiconductor memory temporarily storing a program executed by the CPU 41 and data used by the CPU 41 for arithmetic operations. Note that the data processing apparatus 40 may include a memory of a type other than the RAM 42, or may include a plurality of memories.

The HDD 43 is a non-volatile storage device storing programs for software such as an operating system (OS), middleware, or application software, and data. The programs include, for example, a program for causing the data processing apparatus 40 to execute processing for searching for a solution to a discrete optimization problem. Note that the data processing apparatus 40 may include another type of storage device such as a flash memory or a solid state drive (SSD), or may include a plurality of non-volatile storage devices.

The GPU 44 outputs an image to a display 44a connected to the data processing apparatus 40 in accordance with a command from the CPU 41. As the display 44a, a cathode ray tube (CRT) display, a liquid crystal display (LCD), a plasma display panel (PDP), an organic electro-luminescence (OEL) display, or the like may be used.

The input interface 45 acquires an input signal from an input device 45a connected to the data processing apparatus 40, and outputs the input signal to the CPU 41. As the input device 45a, a pointing device such as a mouse, a touch panel, a touch pad, or a trackball, a keyboard, a remote controller, a button switch, or the like may be used. Furthermore, a plurality of types of input devices may be connected to the data processing apparatus 30.

The medium reader 46 is a reading device that reads a program and data recorded on a recording medium 46a. As the recording medium 46a, for example, a magnetic disk, an optical disk, a magneto-optical disk (MO), a semiconductor memory, or the like may be used. The magnetic disk includes a flexible disk (FD) and an HDD. The optical disk includes a compact disc (CD) and a digital versatile disc (DVD).

The medium reader 46 copies, for example, a program and data read from the recording medium 46a to another recording medium such as the RAM 42 or the HDD 43. The read program is executed by, for example, the CPU 41. Note that the recording medium 46a may be a portable recording medium, and may be used for distribution of a program and data. Furthermore, the recording medium 46a or the HDD 43 may be referred to as a computer-readable recording medium.

The communication interface 47 is an interface that is connected to a network 47a and communicates with another information processing device via the network 47a. The communication interface 47 may be a wired communication interface connected to a communication device such as a switch by a cable, or may be a wireless communication interface connected to a base station by a wireless link.

Next, functions and processing procedures of the data processing apparatus 40 will be described.

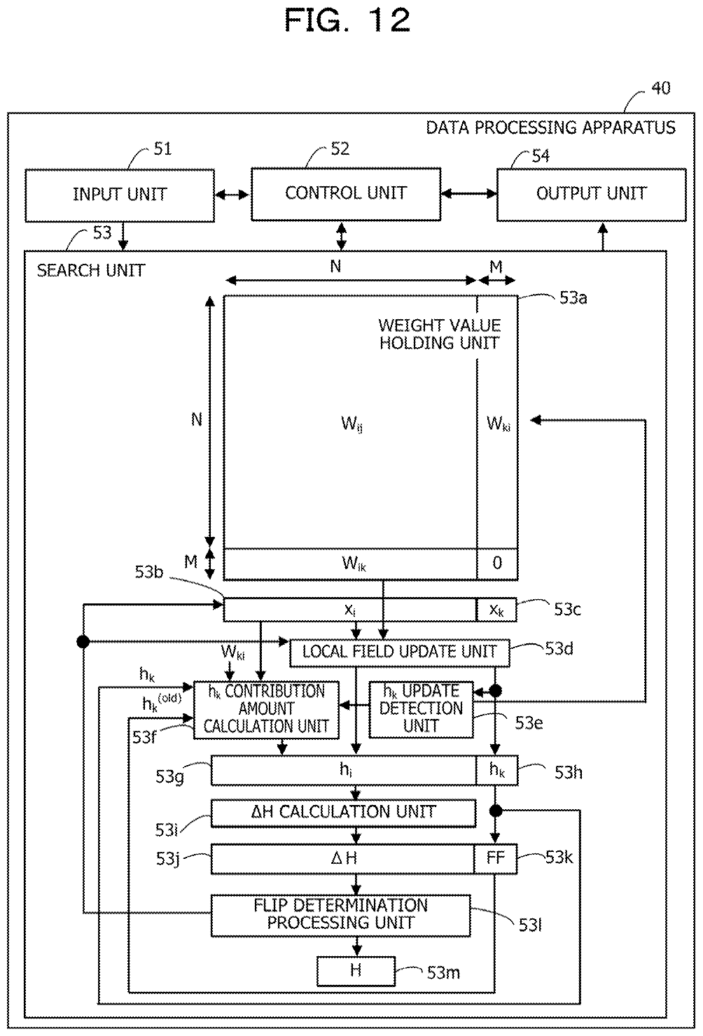

FIG. 12 is a block diagram illustrating a functional example of the data processing apparatus.

The data processing apparatus 40 includes an input unit 51, a control unit 52, a search unit 53, and an output unit 54.

The input unit 51, the control unit 52, the search unit 53, and the output unit 54 may be implemented by using, for example, a program module executed by the CPU 41 or a storage area (register or cache memory) in the CPU 41. Note that the search unit 53 may be further implemented by using a storage area secured in the RAM 42 or the HDD 43.

The input unit 51 receives, for example, input of initial values of N state variables, problem information, and calculation conditions. The problem information includes, for example, Wᵢⱼ, bᵢ, and γₖ in Expression (10) in addition to Wₖᵢ and bₖ in Expression (8). The calculation conditions include, for example, the number of replicas, a replica exchange cycle, and a value of a temperature parameter set for each replica in a case where the replica exchange method is executed, a temperature parameter change schedule in a case where the simulated annealing method is performed, calculation end conditions, and the like.

These pieces of information may be input by operation of the input device 45a by a user, or may be input via the recording medium 46a or the network 47a.

The control unit 52 controls each unit of the data processing apparatus 40 to execute processing to be described later.

The search unit 53 repeats flip determination processing and update processing under the control of the control unit 52, thereby searching for a state where a value (energy) of an evaluation function is minimized.

The output unit 54 outputs a search result (calculation result) by the search unit 53.

For example, the output unit 54 may output the calculation result to the display 44a to be displayed, transmit the calculation result to another information processing device via the network 47a, or store the calculation result in an external storage device.

The search unit 53 includes a weight value holding unit 53a, a state variable holding unit 53b, an auxiliary variable holding unit 53c, a local field update unit 53d, an hₖ update detection unit 53e, and an hₖ contribution amount calculation unit 53f. Moreover, the search unit 53 includes an hᵢ holding unit 53g, an hₖ holding unit 53h, a ΔH calculation unit 53i, a ΔH holding unit 53j, a flip-flop (FF) 53k, a flip determination processing unit 53l, and an H holding unit 53m.

The weight value holding unit 53a holds N×N Wᵢⱼ's, and also holds M×N Wₖᵢ's and N×M Wᵢₖ's. Note that, since Wₖᵢ=Wᵢₖ, the weight value holding unit 53a does not need to hold N×M Wᵢₖ's. Furthermore, the weight value holding unit 53a does not need to hold Wₖᵢ whose value is 0.

The state variable holding unit 53b holds values of N state variables (xᵢ). Furthermore, in a case where a state variable of a flip candidate is specified among the N state variables, the state variable holding unit 53b outputs a change amount of a value of the state variable. For example, in a case where xⱼ is specified, Δxⱼ=1−2xⱼ is output.

The auxiliary variable holding unit 53c holds values of M auxiliary variables (xₖ). For example, xₖ is used to detect whether a constraint condition is satisfied, and xₖ is the same as that used in the data processing apparatus 30 of the second comparative example described above. In FIG. 12, illustration of a configuration for updating xₖ is omitted. As indicated in FIG. 9, in a case where hₖ>0, g(hₖ)>0 and a constraint condition violation occurs. Thus, for example, a configuration is provided in which xₖ=1 in a case where hₖ>0, and xₖ=0 in a case where hₖ≤0. However, the data processing apparatus 40 of the present embodiment does not need to use xₖ. In that case, the auxiliary variable holding unit 53c is unnecessary.

In a case where a change in a value of a state variable of a flip candidate is permitted (in a case where it is determined that flip is permissible), the local field update unit 53d reads a weight value between the state variable and another state variable from the weight value holding unit 53a, and updates a local field by using the weight value. For example, in a case where it is determined that flip is permissible for xⱼ, the local field update unit 53d updates hᵢ by adding WᵢⱼΔxⱼ to each hᵢ.

Furthermore, in a case where it is determined that flip is permissible for the state variable of the flip candidate, the local field update unit 53d reads a weight value whose value is non-zero among weight values between the state variable and M local fields (hₖ), and updates hₖ by using the weight value. For example, in a case where it is determined that flip is permissible for xⱼ, the local field update unit 53d updates hₖ by adding WₖⱼΔxⱼ to hₖ.

The hₖ update detection unit 53e detects update of hₖ.

The hₖ contribution amount calculation unit 53f reads non-zero Wₖᵢ from the weight value holding unit 53a in order to calculate a change amount of hᵢ (δhᵢ of FIG. 7) due to a change in a value of hₖ whose update is detected. Moreover, the hₖ contribution amount calculation unit 53f acquires hₖ from the hₖ holding unit 53h, and acquires hₖ^{(old)} from the FF 53k. Then, the hₖ contribution amount calculation unit 53f calculates δhᵢ, and updates hᵢ by adding δhᵢ to the original hᵢ.

The hᵢ holding unit 53g holds N hᵢ's.

The hₖ holding unit 53h holds M hₖ's.

The ΔH calculation unit 53i calculates ΔH based on a local field corresponding to a state variable of a flip candidate. For example, in a case where the flip candidate is xⱼ, the ΔH calculation unit 53i calculates ΔHⱼ=−hⱼΔxⱼ.

The ΔH holding unit 53j holds ΔHⱼ calculated by the ΔH calculation unit 53i.

The FF 53k holds hₖ, and delays timing of outputting hₖ, thereby supplying hₖ^{(old)} to the hₖ contribution amount calculation unit 53f.

The flip determination processing unit 53l performs flip determination processing to determine whether or not flip is permissible for a state variable of a flip candidate based on a result of comparison between ΔH and a predetermined value. The predetermined value is, for example, a noise value obtained based on a random number and a value of a temperature parameter. For example, in a case where −ΔH≥log(rand)×T, the flip determination processing unit 53l determines that a change in a value of the state variable of the flip candidate is permitted.

Furthermore, the flip determination processing unit 53l sends an identification number of a state variable for which it is determined that flip is permissible to the state variable holding unit 53b to update a value of the state variable.

Moreover, the flip determination processing unit 53l updates H(x) held in the H holding unit 53m based on ΔH generated by a change in the value of the state variable for which it is determined that flip is permissible.

The H holding unit 53m holds H(x). Note that the H holding unit 53m may hold H(x) and a state in a case where the energy becomes the minimum until then.

Next, an operation example of the data processing apparatus 40 of the second embodiment will be described.

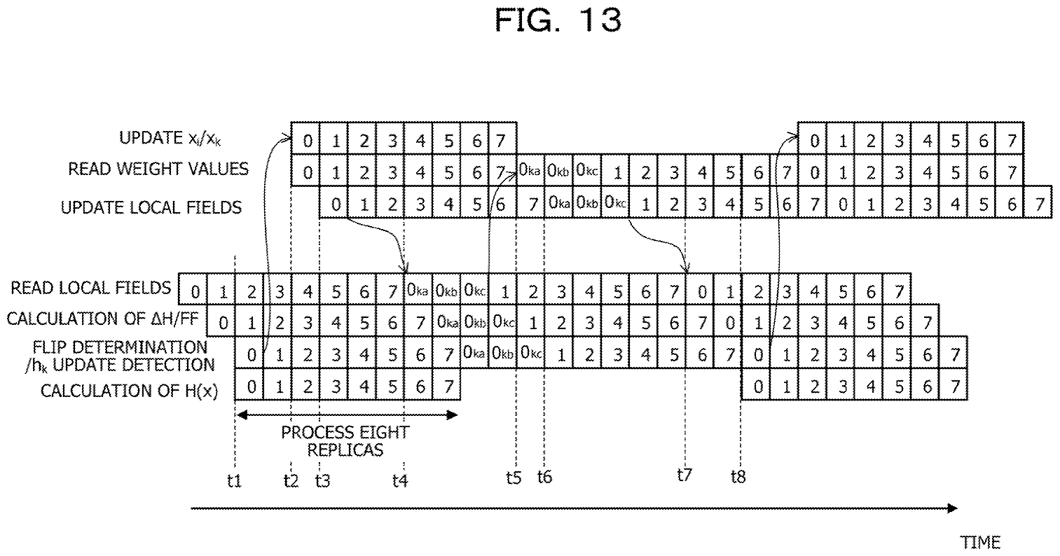

FIG. 13 is a diagram illustrating the operation example of the data processing apparatus of the second embodiment. In FIG. 13, an example in which pipeline processing is performed by using eight replicas is indicated. 0 to 7 are replica numbers. In FIG. 13, details of processing for a replica with the replica number=0 are indicated, and other replicas are indicated in a simplified manner.

In the replica with the replica number=0, flip determination processing is performed (t1), and xᵢ and xₖ are updated according to a result thereof, and weight values for updating hᵢ and hₖ are read (t2). Then, hᵢ and hₖ are updated by the local field update unit 53d (t3). In a case where three hₖ (represented as 0ₖₐ, 0_{kb}, and 0_{kc} in FIG. 13) are updated, for them, reading, output of hₖ^{(old)} by the FF 53k, and update detection of hₖ by hₖ update detection unit 53e are performed in order (t4 to t5).

Then, a corresponding Wₖᵢ is read in order from hₖ for which the update detection is ended (t5), and hᵢ is updated based on δhᵢ described above by the hₖ contribution amount calculation unit 53f (t6). Thereafter, the updated hᵢ is read (t7), and calculation of ΔH, flip determination processing, and calculation of H(x) are performed (t8).

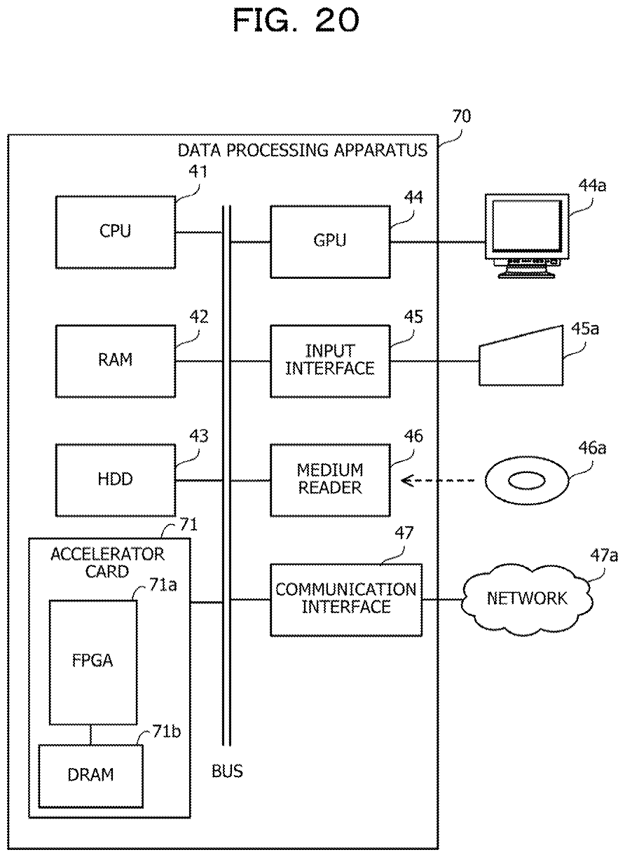

Incidentally, the search unit 53 illustrated in FIG. 12 may also be implemented by using an electronic circuit such as an FPGA as described later (see FIG. 20). For example, the hₖ contribution amount calculation unit 53f of the search unit 53 may be implemented by the following circuit.

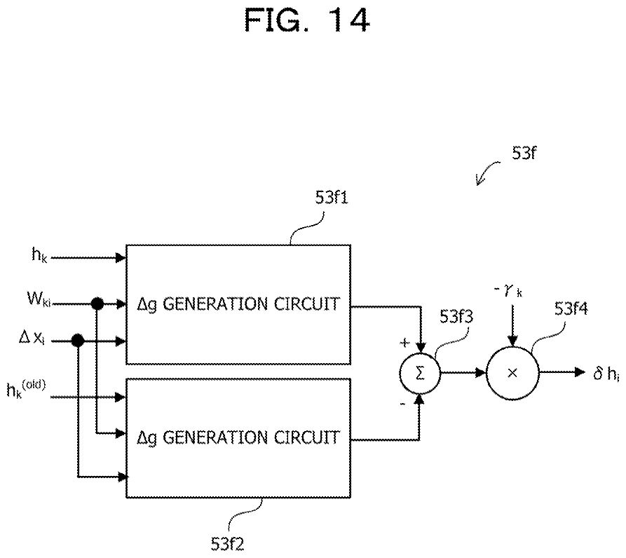

FIG. 14 is a diagram illustrating a circuit example of the hₖ contribution amount calculation unit.

The hₖ contribution amount calculation unit 53f includes Δg generation circuits 53f1 and 53f2, an adder 53f3, and a multiplier 53f4.

The Δg generation circuit 53f1 generates (calculates) and outputs Δg(hₖ, WₖᵢΔxᵢ) indicated in Expression (12) based on Expression (11).

The Δg generation circuit 53f2 generates (calculates) and outputs Δg(hₖ^{(old)}, WₖᵢΔxᵢ) indicated in Expression (12) based on Expression (11).

The adder 53f3 calculates and outputs Δg(hₖ, WₖᵢΔxᵢ)−Δg(hₖ^{(old)}, WₖᵢΔxᵢ).

The multiplier 53f4 outputs δhᵢ, which is a value obtained by multiplying Δg(hₖ, WₖᵢΔxᵢ)−Δg(hₖ^{(old)}, WₖᵢΔxᵢ), which is the output of the adder 53f3, by −γₖ.

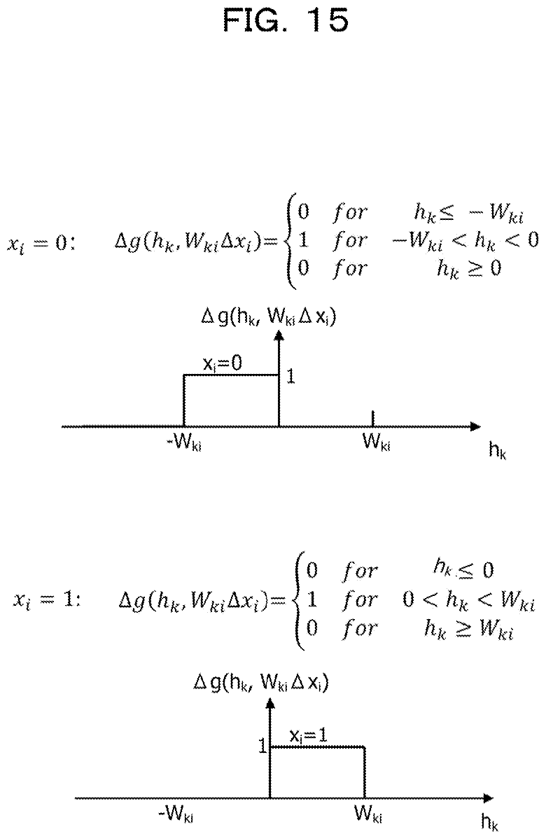

FIG. 15 is a diagram illustrating a first calculation example of Δg.

In FIG. 15, a calculation example of Δg in a case where g(h) is a step function (u(h)) is indicated.

In a case where a value before a change is xᵢ=0, Δg(hₖ, WₖᵢΔxᵢ) is 0 in a case where hₖ≤−Wₖᵢ, 1 in a case where −Wₖᵢ<hₖ<0, and 0 in a case where hₖ≥0.

In a case where the value before the change is xᵢ=1, Δg(hₖ, WₖᵢΔxᵢ) is 0 in a case where hₖ≤0, 1 in a case where 0<hₖ<Wₖᵢ, and 0 in a case where hₖ≥Wₖᵢ.

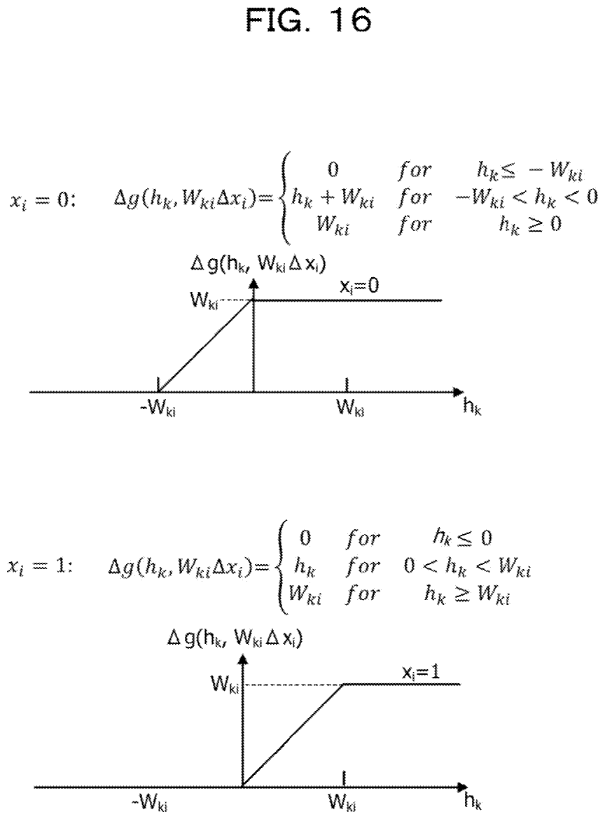

FIG. 16 is a diagram illustrating a second calculation example of Δg.

In FIG. 16, a calculation example of Δg in a case where g(h) is a Max function (max[0, h]) is indicated.

In a case where a value before a change is xᵢ=0, Δg(hₖ, WₖᵢΔxᵢ) is 0 in a case where hₖ≤−Wₖᵢ, hₖ+Wₖᵢ in a case where −Wₖᵢ<hₖ<0, and Wₖᵢ in a case where hₖ≥0.

In a case where the value before the change is xᵢ=1, Δg(hₖ, WₖᵢΔxᵢ) is 0 in a case where hₖ≤0, hₖ in a case where 0<hₖ<Wₖᵢ, and Wₖᵢ in a case where hₖ≥Wₖᵢ.

Note that it is also possible to combine Δg as indicated in FIG. 15 and FIG. 16.

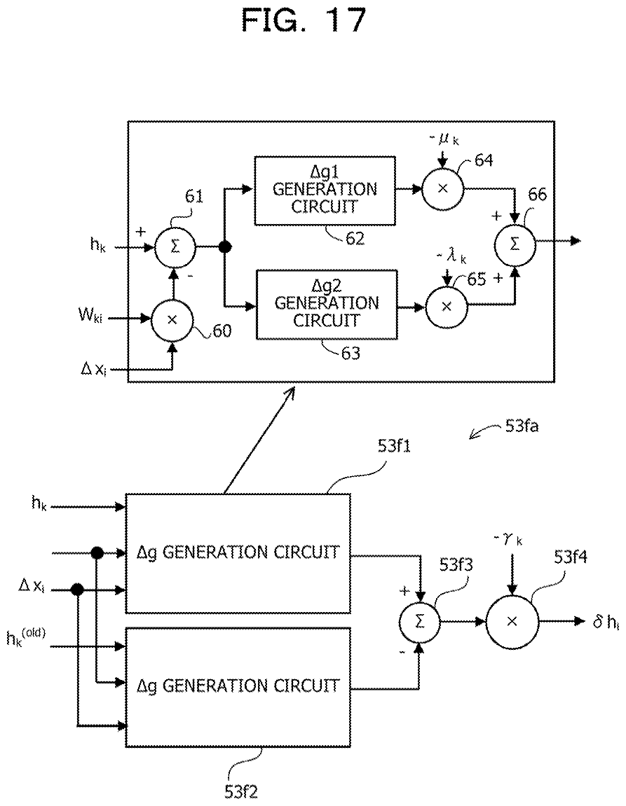

FIG. 17 is a diagram illustrating an example of the Δg generation circuits that generate Δg by combining a plurality of the penalty functions.

The Δg generation circuit 53f1 includes a multiplier 60, an adder 61, a Δg1 generation circuit 62, a Δg2 generation circuit 63, multipliers 64 and 65, and an adder 66.

The multiplier 60 outputs WₖᵢΔxᵢ, which is a product of Wₖᵢ and Δxᵢ.

The adder 61 outputs the sum of hₖ and −WₖᵢΔxᵢ.

The Δg1 generation circuit 62 generates, for example, Δg(hₖ, WₖᵢΔxᵢ) based on the step function, which is indicated in FIG. 15.

The Δg2 generation circuit 63 generates, for example, Δg(hₖ, WₖᵢΔxᵢ) based on the Max function, which is indicated in FIG. 16.

The multiplier 64 outputs a value obtained by multiplying Δg(hₖ, WₖᵢΔxᵢ) generated by the Δg1 generation circuit 62 by −μₖ.

The multiplier 65 outputs a value obtained by multiplying Δg(hₖ, WₖᵢΔxᵢ) generated by the Δg2 generation circuit 63 by −λₖ.

The adder 66 outputs a value obtained by adding the output of the multipliers 64 and 65.

Hereinafter, a processing procedure (data processing method) of the data processing apparatus 40 of the second embodiment will be described by using flowcharts.

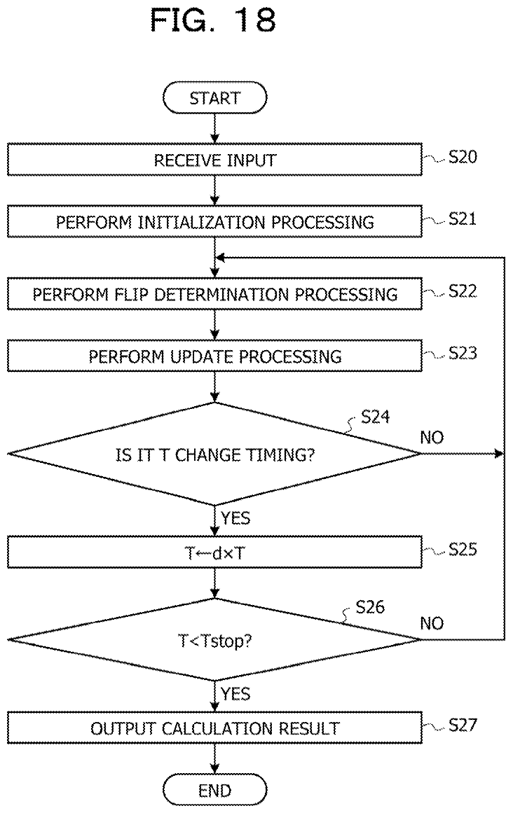

FIG. 18 is a flowchart illustrating a flow of an example of the data processing method.

Note that, in the following, an example in which search is performed by the simulated annealing method is indicated.

Step S20: The input unit 51 receives input of initial values of N state variables, problem information, and calculation conditions (for example, a parameter d, Tstop, and the like to be described later). The initial values of the N state variables are held in the state variable holding unit 53b. Furthermore, a weight value included in the problem information is held in the weight value holding unit 53a. The calculation conditions are supplied to the control unit 52.

Step S21: The control unit 52 performs initialization processing. In the initialization processing, for example, the following processing is performed.

The control unit 52 calculates an initial value of hₖ indicated in Expression (8) and an initial value of hᵢ indicated in Expression (10) based on the initial values of the N state variables and the problem information. The calculated initial values of N hᵢ's are held in the hᵢ holding unit 53g, and the calculated initial values of M hₖ's are held in the hₖ holding unit 53h.

Furthermore, the control unit 52 calculates an initial value of H(x) based on the initial values of the N state variables and the problem information. The calculated initial value of H(x) is held in, for example, the H holding unit 53m.

Step S22: The search unit 53 performs flip determination processing. In the processing of Step S22, for example, a state variable of a flip candidate is selected, and ΔH is calculated based on hᵢ corresponding to the state variable. Then, based on a result of comparison between ΔH and a predetermined value, it is determined whether or not flip is permissible for the state variable of the flip candidate. The predetermined value is a noise value (for example, log(rand)×T) obtained based on a random number and a value of a temperature parameter (T).

Step S23: The search unit 53 performs update processing. In the processing of Step S23, a value of the state variable for which it is determined that flip is permissible is updated. Moreover, hᵢ, hₖ, and H(x) are updated as the value of the state variable is updated. An example of a procedure of the update processing of the local fields (hᵢ and hₖ) will be described later.

Step S24: The control unit 52 determines whether or not it is T change timing. For example, each time the state variable is updated a predetermined number of times, it is determined that it is the T change timing. The control unit 52 performs processing of Step S25 in a case where it is determined that it is the T change timing, and repeats the processing from Step S22 in a case where it is determined that it is not the T change timing.

Step S25: The control unit 52 updates T by performing d×T. One of parameters included in the calculation conditions is represented by d, and d has a value smaller than 1 (for example, 0.99 or the like).

Step S26: The control unit 52 determines whether or not T<Tstop holds. A parameter representing a calculation end condition is represented by Tstop. In a case where the control unit 52 determines that T<Tstop holds, processing of Step S27 is performed, and in a case where the control unit 52 determines that T<Tstop does not hold, the processing from Step S22 is repeated.

Step S27: The output unit 54 outputs a calculation result. With this configuration, the processing ends. The calculation result is, for example, total energy and a state in a case where the energy becomes the minimum until then.

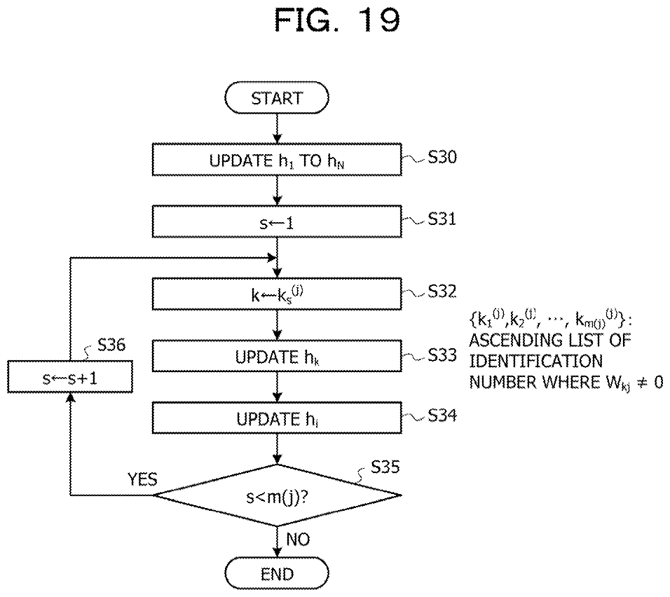

FIG. 19 is a flowchart illustrating a flow of an example of the local field update processing.

Step S30: In a case where it is determined that flip is permissible for the state variable of the flip candidate, the local field update unit 53d updates N local fields (h₁ to h_{N}) corresponding to the N state variables. In a case where a change in a value of xⱼ of the flip candidate is permitted (in a case where it is determined that flip is permissible), the local field update unit 53d reads the N Wᵢⱼ's from the weight value holding unit 53a, and updates the N hᵢ's by adding WᵢⱼΔxⱼ to each of the N hᵢ's.

Step S31: The control unit 52 sets 1 to a loop variable s.

Step S32: The control unit 52 sets kₛ^{(j)} as k, which is an identification number of a constraint term. The s-th k included in an ascending list {k₁^{(j)}, k₂^{(j)}, . . . kₘ₍ⱼ₎^{(j)}} of the identification number k where Wₖⱼ≠0 is represented by kₛ^{(j)}. Note that j is an identification number of the state variable for which it is determined that flip is permissible. Such a list is, for example, created in advance for each of the N state variables and stored in a storage unit (not illustrated).

Step S33: The local field update unit 53d updates hₖ. For example, in a case where it is determined that flip is permissible for xⱼ, the local field update unit 53d updates hₖ by adding WₖⱼΔxⱼ to hₖ.

Step S34: The hₖ contribution amount calculation unit 53f updates hᵢ. The hₖ contribution amount calculation unit 53f updates hᵢ corresponding to a state variable whose weight value with hₖ is non-zero based on Expression (12).

Step S35: The control unit 52 determines whether or not s<m(j) holds. The control unit 52 performs processing of Step S36 in a case where it is determined that s<m(j) holds, and ends the update processing in a case where it is determined that s<m(j) does not hold.

Step S36: The control unit 52 sets s to s+1. Thereafter, the processing from Step S32 is repeated.

Note that the order of the processing illustrated in FIG. 18 and FIG. 19 is an example, and the order of the processing may be appropriately changed.

According to the data processing apparatus 40 and the data processing method of the second embodiment as described above, hᵢ and hₖ may be updated with the degree of parallelism of N+M, and no update is performed for hₖ whose weight value with the state variable whose value is permitted to change is 0 (see FIG. 19). Furthermore, for such hₖ, a value thereof does not change. Thus, hᵢ is not further updated by Expression (12) using that hₖ. Furthermore, hᵢ corresponding to a state variable whose weight value with hₖ whose value has changed is 0 is also not further updated. Thus, a calculation amount may be reduced. Furthermore, a data transfer amount may also be reduced.

Furthermore, according to the data processing apparatus 40 and the data processing method of the second embodiment, hᵢ used for calculating ΔH is the value reflecting not only the change amount of E(x) associated with the change in the value of the state variable but also the change amount of P(x). For example, more accurate ΔH may be calculated. Thus, also at the time of determining whether or not to change the value of the state variable of the flip candidate, the flip determination based on the change amount of the constraint term associated with the change may be made. With this configuration, a solution performance may be improved.

Furthermore, the penalty functions that may be used are not limited to the ReLU type. For example, by using the configuration illustrated in FIG. 17, a penalty function combining a plurality of penalty functions may also be used. With this configuration, it is also possible to properly use an inequality constraint to be observed (hard constraint) and a soft constraint whose violation is permitted by comparison with E(x).

Note that, as described above, the processing contents described above may be implemented by causing the data processing apparatus 40 to execute a program.

The program may be recorded in a computer-readable recording medium (for example, the recording medium 46a). As the recording medium, for example, a magnetic disk, an optical disk, a magneto-optical disk, a semiconductor memory, or the like may be used. The magnetic disk includes an FD and an HDD. The optical disk includes a CD, a CD-recordable (R)/rewritable (RW), a DVD, and a DVD-R/RW. The program may be recorded in a portable recording medium and distributed. In that case, the program may be copied from the portable recording medium to another recording medium (for example, the HDD 43) and then executed.

FIG. 20 is a diagram illustrating another example of the data processing apparatus. In FIG. 20, elements same as the elements illustrated in FIG. 11 are denoted by the same reference signs.

A data processing apparatus 70 includes an accelerator card 71 connected to a bus.

The accelerator card 71 is a hardware accelerator that searches for a solution to a discrete optimization problem. The accelerator card 71 includes an FPGA 71a and a DRAM 71b.

In the data processing apparatus 70, the FPGA 71a performs, for example, the processing of the control unit 52 and the search unit 53 illustrated in FIG. 12.

Furthermore, the DRAM 71b functions as, for example, the weight value holding unit 53a illustrated in FIG. 12.

Note that there may be a plurality of the accelerator cards 71.

In the above, one aspect of the data processing apparatus, the program, and the data processing method according to the embodiments has been described based on the embodiments. However, these are merely examples, and are not limited to the description above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing apparatus comprising:
one or more memories; and
one or more processors coupled to the one or more memories and the one or more processors configured to:
search for a combination of values of a plurality of state variables that minimizes or maximizes a value of an Ising-type evaluation function that includes the plurality of state variables,
store total energy that is a sum of a plurality of constraint terms and the value of the evaluation function, the values of the plurality of state variables, a first weight value between each of the plurality of state variables, a second weight value between one of the plurality of state variables and each of a plurality of constraint conditions, a first local field, and a second local field in the one or more memories, the plurality of constraint terms including values that correspond to whether each of the plurality of constraint conditions is violated, the first local field indicating a first change amount of the total energy when a value of each of the plurality of state variables changes, the second local field being used to specify a constraint violation amount for each of the plurality of the constraint conditions, and
repeat determining whether to permit a change in a value of a first state variable among the plurality of state variables based on the first local field, and when the change in the value of the first state variable is permitted, updating the first local field based on the first weight value, updating the second local field that corresponds to a constraint condition in which the second weight value with the first state variable is non-zero based on the second weight value, and updating the first local field based on the second local field before the updating and the second local field after the updating.

2. The data processing apparatus according to claim 1, wherein the first local field is represented by a difference between a second change amount of the value of the evaluation function and a sum total of a third change amounts of each of the plurality of constraint terms when the value of each of the plurality of state variables changes.

3. The data processing apparatus according to claim 2, wherein the one or more processors are further configured to
when the change in the value of the first state variable is permitted, updating the first local field based on a difference between the third change amount acquired by using the second local field before the updating and the third change amount acquired by using the second local field after the updating.

4. The data processing apparatus according to claim 1, wherein the plurality of constraint terms is represented by at least one function selected from a step function, a Max function, and a combination of the step function and the Max function.

5. A non-transitory computer-readable storage medium storing a data processing program that causes at least one computer to execute a process, the process comprising:
searching for a combination of values of a plurality of state variables that minimizes or maximizes a value of an Ising-type evaluation function that includes the plurality of state variables;
storing total energy that is a sum of a plurality of constraint terms and the value of the evaluation function, the values of the plurality of state variables, a first weight value between each of the plurality of state variables, a second weight value between one of the plurality of state variables and each of a plurality of constraint conditions, a first local field, and a second local field, the plurality of constraint terms including values that correspond to whether each of the plurality of constraint conditions is violated, the first local field indicating a first change amount of the total energy when a value of each of the plurality of state variables changes, the second local field being used to specify a constraint violation amount for each of the plurality of the constraint conditions; and
repeating determining whether to permit a change in a value of a first state variable among the plurality of state variables based on the first local field, and when the change in the value of the first state variable is permitted, updating the first local field based on the first weight value, updating the second local field that corresponds to a constraint condition in which the second weight value with the first state variable is non-zero based on the second weight value, and updating the first local field based on the second local field before the updating and the second local field after the updating.

6. The non-transitory computer-readable storage medium according to claim 5, wherein the first local field is represented by a difference between a second change amount of the value of the evaluation function and a sum total of a third change amounts of each of the plurality of constraint terms when the value of each of the plurality of state variables changes.

7. The non-transitory computer-readable storage medium according to claim 6, wherein the process further comprising
when the change in the value of the first state variable is permitted, updating the first local field based on a difference between the third change amount acquired by using the second local field before the updating and the third change amount acquired by using the second local field after the updating.

8. The non-transitory computer-readable storage medium according to claim 5, wherein the plurality of constraint terms is represented by at least one function selected from a step function, a Max function, and a combination of the step function and the Max function.

9. A data processing method for a computer to execute a process comprising:
searching for a combination of values of a plurality of state variables that minimizes or maximizes a value of an Ising-type evaluation function that includes the plurality of state variables;
storing total energy that is a sum of a plurality of constraint terms and the value of the evaluation function, the values of the plurality of state variables, a first weight value between each of the plurality of state variables, a second weight value between one of the plurality of state variables and each of a plurality of constraint conditions, a first local field, and a second local field, the plurality of constraint terms including values that correspond to whether each of the plurality of constraint conditions is violated, the first local field indicating a first change amount of the total energy when a value of each of the plurality of state variables changes, the second local field being used to specify a constraint violation amount for each of the plurality of the constraint conditions; and
repeating determining whether to permit a change in a value of a first state variable among the plurality of state variables based on the first local field, and when the change in the value of the first state variable is permitted, updating the first local field based on the first weight value, updating the second local field that corresponds to a constraint condition in which the second weight value with the first state variable is non-zero based on the second weight value, and updating the first local field based on the second local field before the updating and the second local field after the updating.

10. The data processing method according to claim 9, wherein the first local field is represented by a difference between a second change amount of the value of the evaluation function and a sum total of a third change amounts of each of the plurality of constraint terms when the value of each of the plurality of state variables changes.

11. The data processing method according to claim 10, wherein the process further comprising
when the change in the value of the first state variable is permitted, updating the first local field based on a difference between the third change amount acquired by using the second local field before the updating and the third change amount acquired by using the second local field after the updating.

12. The data processing method according to claim 9, wherein the plurality of constraint terms is represented by at least one function selected from a step function, a Max function, and a combination of the step function and the Max function.
